(19) United States
(12) Patent Application Publication
(10) Pub. No.: US 2016/0202390 A1
(43) Pub. Date: Jul. 14, 2016

(54) In-Situ Wellbore, Core and Cuttings Information System

(71) Applicant: LANDMARK GRAPHICS CORPORATION, Houston, TX (US)

(72) Inventors: Travis S Ramsay, Rosenberg, TX (US); Amit Kumar, Houston, TX (US); Mamdouh Abdel-Aal Shebl, Katy, TX (US); Matt James Croy, Richmond, TX (US); Kenneth E. Williams, Houston, TX (US)

(21) Appl. No.: 14/915,851

(22) PCT Filed: Oct. 1, 2013
(86) PCT No.: PCT/US13/62928

§ 371 Date: Mar. 1, 2016

(51) Int. Cl. G01V 99/00; E21B 49/00

(52) U.S. Cl. CPC G01V 99/005; E21B 49/005

(57) ABSTRACT

Systems and methods for generation of in-situ wellbore, core and cuttings information systems. An image and image derivative based property visualization, analysis and enhancement system is provided, which utilizes various types of image data, such as digital rock physics and physical laboratories, petrographic analysis and the in-situ wellbore imaging and derivative products of image segmentation in the construction of a static earth model.

### CROSS-REFERENCE TO RELATED APPLICATIONS

None.

### STATEMENT REGARDING FEDERALLY SPONSORED RESEARCH

Not applicable.

### FIELD OF THE DISCLOSURE

The present disclosure generally relates to an in-situ wellbore, core and cuttings information system. In particular, the present disclosure relates to systems and methods for visualization, analysis and enhancement of an image-based property based on in-situ wellbore, core and cuttings information and construction of a static earth model.

### BACKGROUND

Various image data and applicable derivative products are generated and stored with regard to well sites. These may include indexed (digital image segmentation) stacked images which when segmented, may be used to create a three dimensional reconstruction of the imaged object.

The typical, or classic, earth modeling workflow first loads non-spurious data, then creates an assigned wellbore image by assigning non-spurious core property data to wellbore images. Thereafter, the typical earth modeling workflow builds a three-dimensional stratigraphic geocellular grid using geologic framework data for stratigraphic modeling. This stratigraphic geocellular grid, the non-spurious core property data, and the assigned wellbore image are then used to create a lithotype proportion map. The lithotype proportion map is then used to generate a facies simulation, which is in turn used to generate a static earth model.

However, because these data include different locations and scales, generation of a static earth model has proven difficult. Systems that attempted to provide data management lacked quantitative information with respect to the displayed images and did not use the displayed images beyond visualization purposes.

The typical earth modeling workflow does not allow the input and spatial propagation of axial dependent properties, effectively computing tensor permeabilities (and connected porosity if desired) along the X, Y and Z axis orientations. These earth models do not provide tensor characterized properties, i.e. direction oriented permeability, connected porosity, stress with all axial components as a result of step.

Moreover, while “core data” has been included in these earth models, they make no use of no wellbore/core images or (low/high resolution) images or image derivatives (in the form of segmented three-dimensional reconstructions) of cores in the construction of a static earth model, with those images and derivative products having referenced rock properties assigned to them. In other instances, the display has been limited to images of cores with rock properties as a “wiggle” log. Current industry rationale, thus assigns no further value beyond visual analysis for computed tomography and petrographic images.

### BRIEF DESCRIPTION OF THE DRAWINGS

The present invention is described below with references to the accompanying drawings in which like elements are referenced with like reference numerals, and in which:

FIG. 1 is a flow diagram illustrating one embodiment of a method 100 for implementing the present disclosure.

FIG. 2 illustrates an example of a continuous well log with display of core curves of permeability as loaded in step 102.

FIG. 3 illustrates an example of a discretized permeability log trace mapped to a three-dimensional stratigraphic geocellular grid built in step 112.

FIG. 4 illustrates an example of a single depth referenced computed tomography whole core image, wherein computer rock properties are displayed for the indexed region in the assigned wellbore image created in step 108.

FIG. 5 illustrates an example of a multiple depth referenced whole core images displayed along the vertical axis of the core in the constrained lithotype proportion map generated in step 120.

FIG. 6 illustrates an example of a core segmentation, derivative of the assigned wellbore image created in step 108.

FIG. 7 illustrates an example of a borehole image showing the in-situ well bore for the enhanced three-dimensional stratigraphic geocellular grid built in step 114.

FIG. 8A illustrates an example of a stacked circular display property, loaded in step 102, mapped to the enhanced three-dimensional stratigraphic geocellular grid built in step 114, demonstrating tensor-based attributes in the horizontal direction.

FIG. 8B illustrates an example of a top view of a singular pointset data property co-incident with the stacked circular display pointset of FIG. 8A illustrating directional (axial) permeability data and porosity data prior to generation of the static earth model in step 128.

FIG. 9 illustrates an example of a geocellular mapped property/grid visualization where the geocellular mapped permeability is superimposed on a background permeability grid (field) in the static earth model generated in step 128.

FIG. 10 illustrates an example of a geocellular mapped permeability property superimposed on a background permeability grid (field) with a geo-referenced computed tomography scan of whole core including its associated rock properties in the static earth model generated in step 128.

FIG. 11 illustrates an example of a geocellular mapped permeability property superimposed on a background permeability (field) with a geo-referenced log including its associated rock properties in the static earth model generated in step 128.

FIG. 12 is a block diagram illustrating one embodiment of a computer system for implementing the present disclosure.

### DETAILED DESCRIPTION OF THE PREFERRED EMBODIMENTS

The present disclosure therefore, overcomes one or more deficiencies in the prior art by providing systems and methods systems for visualization, analysis and enhancement of an image-based property based on in-situ wellbore, core and cuttings information and construction of a static earth model

In one embodiment, the present disclosure includes a method for generating a static earth model, comprising: i) building an enhanced three-dimensional stratigraphic geocellular grid using a three-dimensional stratigraphic geocelluar grid, wellbore image data and a computer system; ii) creating a lithotype proportion map using core property data, an assigned wellbore image, and the enhanced three-dimensional stratigraphic geocellular grid or generating a constrained lithotype proportion map by constraining a smoothing of a lithotype proportion map using trends found in properties of the assigned wellbore image; iii) generating a facies simulation using the lithotype proportion map or the constrained lithotype proportion map, and the enhanced three-dimensional stratigraphic geocellular grid; and iv) generating the static earth model using the enhanced three-dimensional stratigraphic geocellular grid, the facies simulation, a modified well log property curve, porosity data, and permeability data.

In another embodiment, the present disclosure includes a non-transitory program carrier device tangibly carrying computer executable instructions for generating a static earth model, comprising i) building an enhanced three-dimensional stratigraphic geocellular grid using a three-dimensional stratigraphic geocelluar grid and wellbore image data; ii) creating a lithotype proportion map using core property data, an assigned wellbore image, and the enhanced three-dimensional stratigraphic geocellular grid or generating a constrained lithotype proportion map by constraining smoothing of a lithotype proportion map using trends found in properties of the assigned wellbore image; iii) generating a facies simulation using the lithotype proportion map or the constrained lithotype proportion map, and the enhanced three-dimensional stratigraphic geocellular grid; and iv) generating the static earth model using the enhanced three-dimensional stratigraphic geocellular grid, the facies simulation, a modified well log property curve, porosity data, and permeability data.

In yet another embodiment, the present disclosure includes a non-transitory program carrier device tangibly carrying computer executable instructions for generating a static earth model, comprising: i) building an enhanced three-dimensional stratigraphic geocellular grid using a three-dimensional stratigraphic geocelluar grid and wellbore image data; ii) creating an assigned wellbore image by assigning core property data to the wellbore image data; iii) creating a lithotype proportion map or generating a constrained lithotype proportion map by constraining a smoothing of a lithotype proportion map using trends found in properties of the assigned wellbore image; iv) generating a facies simulation using the lithotype proportion map or the constrained lithotype proportion map, and the enhanced three-dimensional stratigraphic geocellular grid; and v) generating a static earth model using the enhanced three-dimensional stratigraphic geocellular grid, the facies simulation, a modified well log property curve, porosity data, and permeability data.

The subject matter of the present disclosure is described with specificity, however, the description itself is not intended to limit the scope of the disclosure. The subject matter thus, might also be embodied in other ways, to include different steps or combinations of steps similar to the ones described herein, in conjunction with other technologies. Moreover, although the term “step” may be used herein to describe different elements of methods employed, the term should not be interpreted as implying any particular order among or between various steps herein disclosed unless otherwise expressly limited by the description to a particular order. While the present description refers to the oil and gas industry, it is not limited thereto and may also be applied in other industries to achieve similar results.

### Method Description

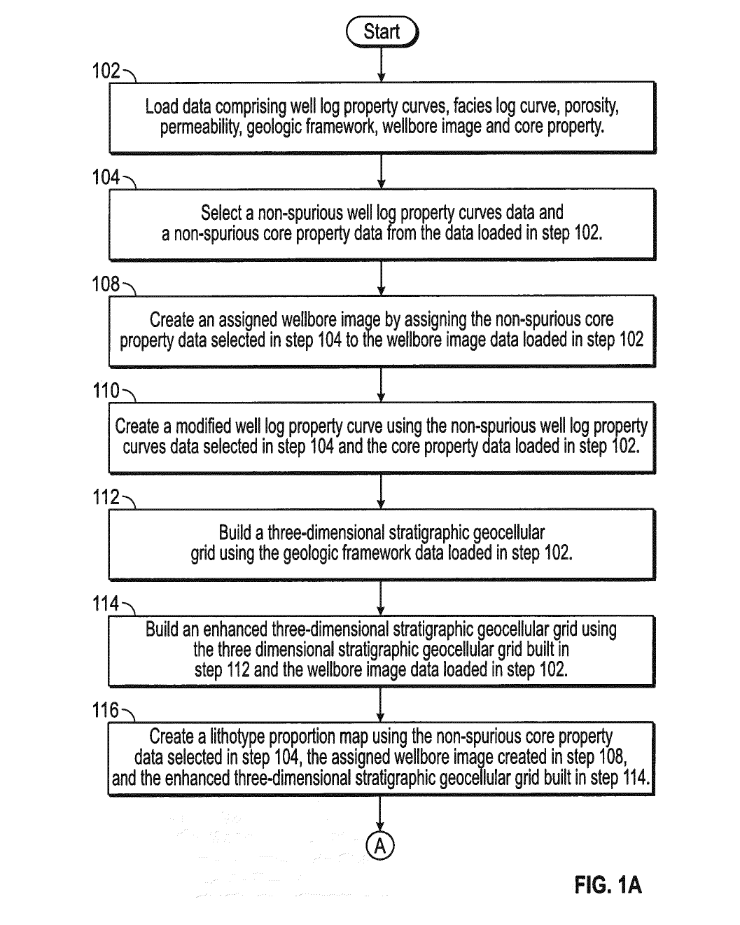

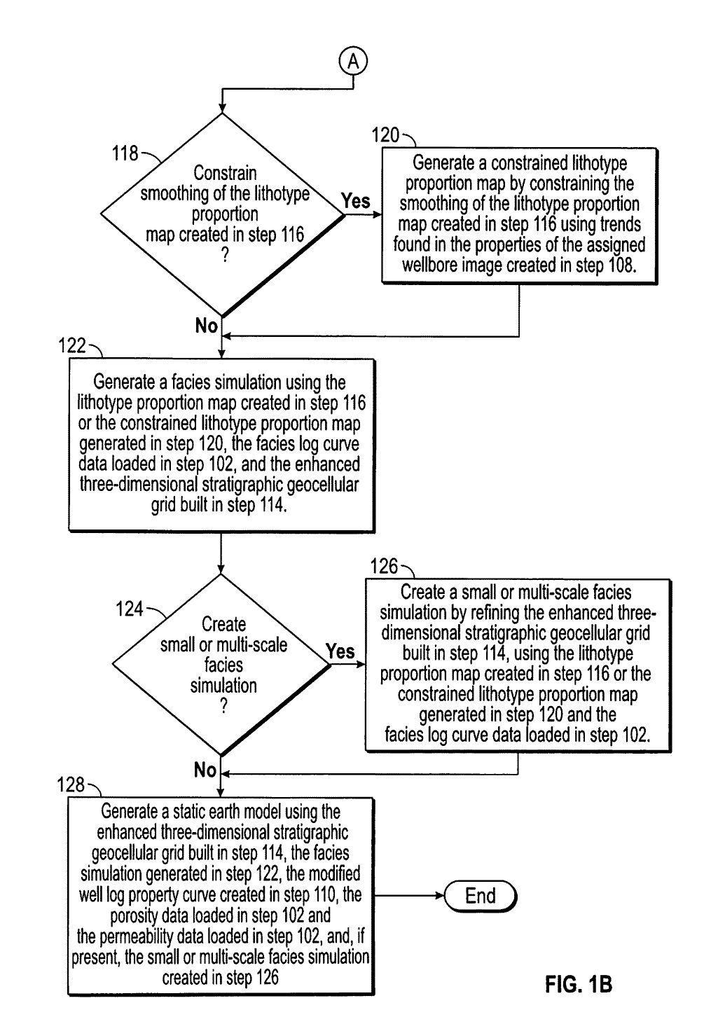

Referring now to FIG. 1, a flow diagram of one embodiment of a method 100 for implementing the present disclosure is illustrated.

In step 102, data is loaded, which may comprise well log property curves, facies log curves, porosity, permeability, geologic frameworks, wellbore images, and core properties, using techniques well known in the art. In FIG. 2, an example of such data comprising a continuous well log with a display of core curves of permeability is illustrated.

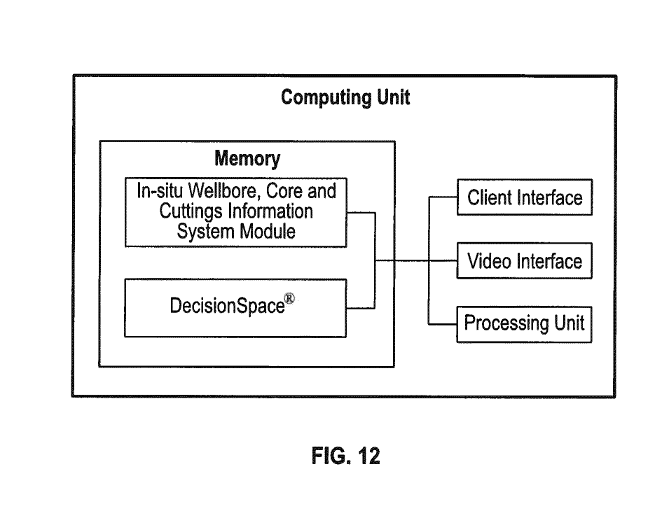

In step 104, a non-spurious well log property curves data and a non-spurious core property data is selected from the data loaded in step 102 using a client interface and/or a video interface described further in reference to FIG. 12. Using data analysis systems well known in the art, the method 100 provides data scrutiny/critiquing to determine well log property curves and non-spurious core property that should be omitted from further modeling work due to spurious characteristics that the well log property curves and/or non-spurious core property may possess. This may include the use of user interaction with a series of plots, such as Q-Q plots, histograms, box plots, and crossplots.

In step 108, an assigned wellbore image is created by assigning the core property data selected in step 104 to the wellbore image data loaded in step 102 using applications well known in the art.

In step 110, a modified well log property curve is created based on the well log property curves data selected in step 104, the core property data selected in step 104 and applications well known in the art. In step 110, wellbore visualization and analysis is provided using initial visualization of core, cuttings, wellbore image logs, and/or segmentation data and the analysis of rock properties, referenced to the wellbore derived images, with respect to petrophysics, rock physics or assessed facies logs. This step may be performed, in part, using a geographical information system technique, which provides for the use of images or segmentation data that have referenced property values assigned to them, i.e. rock properties and fluid properties. Spatially/rock property referenced in-situ wellbore, core and/or cuttings image or segmentation data as a calibration tool may be used to determine where log curves are to be modified.

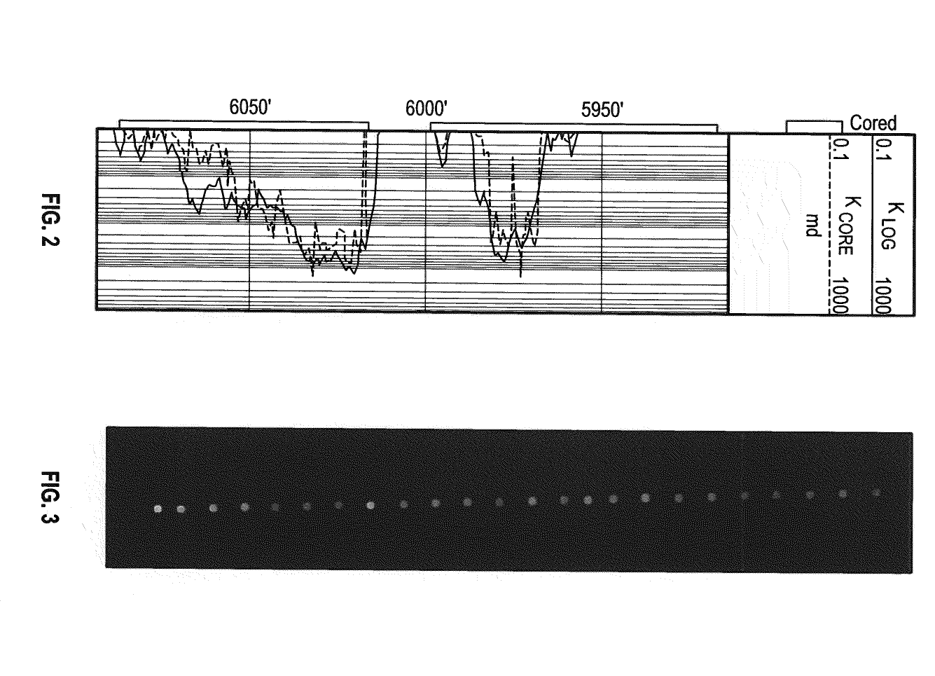

In step 112, a three-dimensional stratigraphic geocellular grid is built using the geologic framework data loaded in step 102 and applications well known in the art. In FIG. 3, an example of a discretized permeability log trace mapped to a three-dimensional stratigraphic geocellular grid as built in step 112, singular in value, direction independent, and displayed according to a user defined sampling rate, is illustrated.

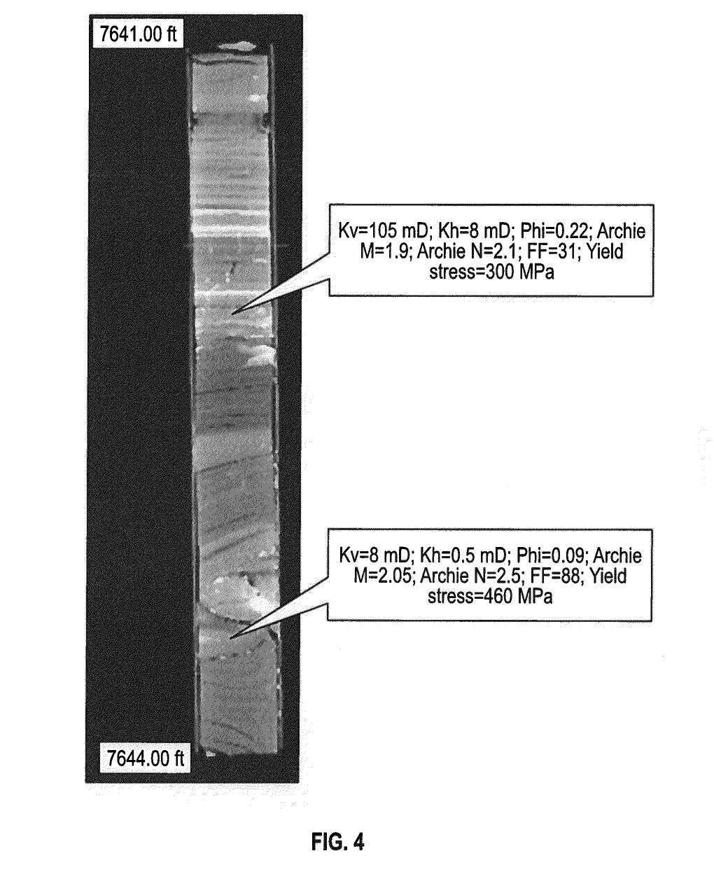

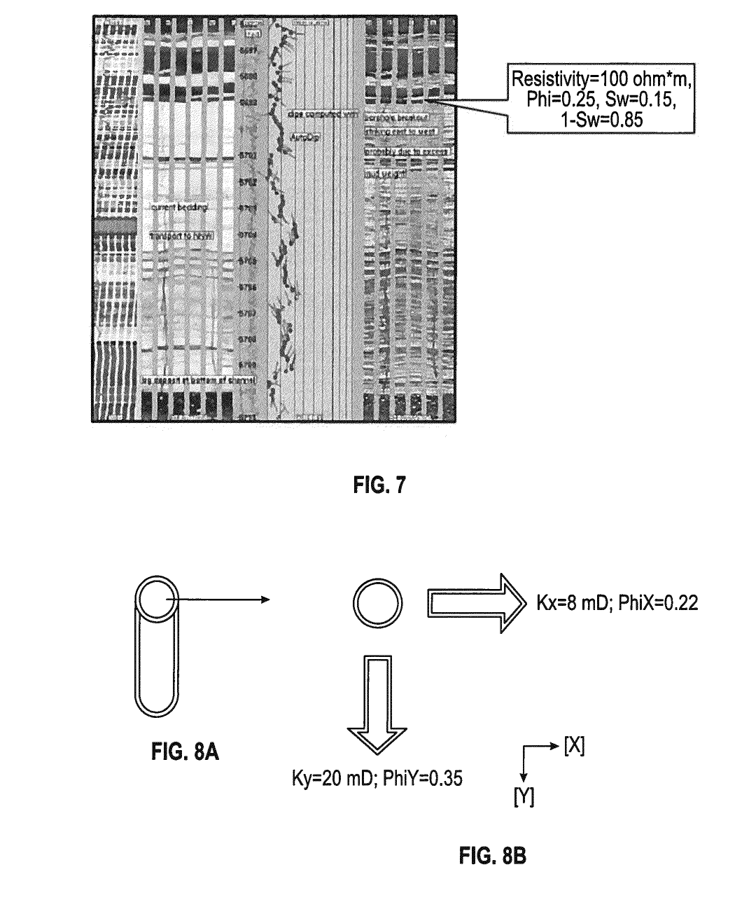

In step 114, an enhanced three-dimensional stratigraphic geocellular grid is built using the three-dimensional stratigraphic geocellular grid built in step 112 and the wellbore image data loaded in step 102. The three-dimensional stratigraphic geocellular grid built in step 112 is enhanced by the user, such as by manipulation using various input devices, such as a combination of keyboard and mouse inputs, by contiguous matching of stratigraphy evidenced in the subsurface description provided by the wellbore image data loaded in step 102 and/or core property data selected in step 104. Thus, the user is able to verify that the stratigraphy corresponding to the subsurface is honored accordingly in the enhanced three-dimensional stratigraphic geocellular grid. A sufficient amount of wellbore image data or core property data ensures that stratigraphic continuity in the enhanced three-dimensional stratigraphic geocellular grid is maintained and corrected where erroneous. The enhanced three-dimensional stratigraphic geocellular grid is built, in part, using a geographical information system technique. Building the enhanced three-dimensional stratigraphic geocellular grid is most suitable where wellbores have been continuously cored or imaged, but may be applied to other data. In FIG. 4, an example of a single depth referenced computed tomography whole core image, wherein computer rock properties are displayed for the indexed region in the assigned wellbore image created in step 108 is illustrated. In FIG. 7, an example of a borehole image showing the in-situ well bore for the enhanced three-dimensional stratigraphic geocellular grid built with step 114 is illustrated. Static enhancements of a borehold image are depicted in Track 2, with computed dips depicted in Track 4, and dynamic enhancements of a borehole image log depicted in Track 5. In FIG. 8A, an example of a stacked circular display property, loaded in step 102, mapped to the enhanced three-dimensional stratigraphic geocellular grid built in step 114, demonstrating tensor-based attributes in the horizontal direction is illustrated.

In step 116, a lithotype proportion map is created using the non-spurious core property data selected in step 104, the assigned wellbore image created in step 108, and the enhanced three-dimensional stratigraphic geocellular grid built in step 114, and applications well known in the art. The user may parameterize the creation of the lithotype proportion map using various input devices, such as a combination of mouse and keyboard.

In step 118, the method 100 determines if smoothing of the lithotype proportion map created in step 116 should be constrained based on trends found in the properties of the assigned wellbore image created in step 108. If smoothing of the lithotype proportion map should not be constrained, then the method 100 proceeds to step 122. If smoothing of the lithotype proportion map should be constrained, then the method 100 proceeds to step 120.

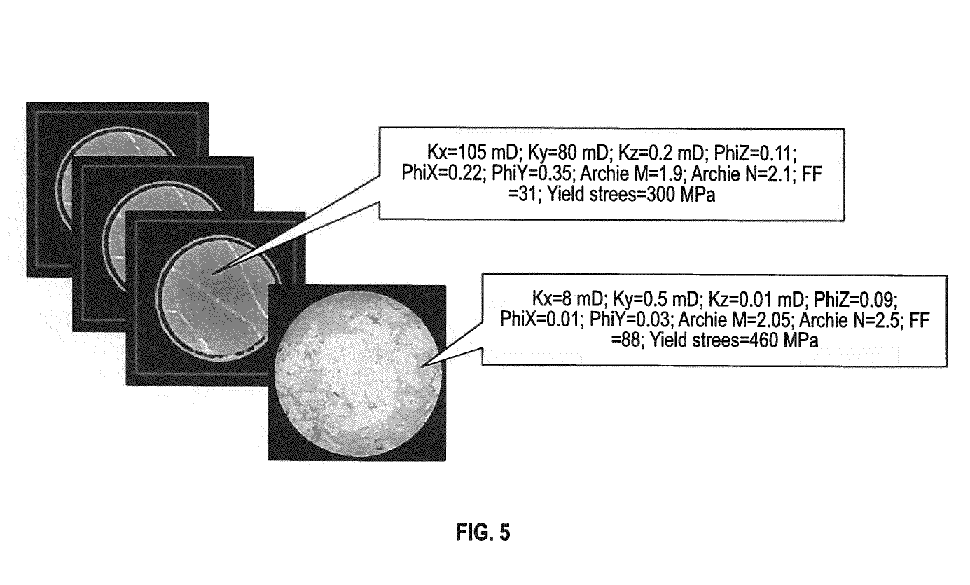

In step 120, smoothing is applied to the lithotype proportion map created in step 116 to create a smoothed lithotype proportion map using trends found in the properties of the assigned wellbore image created in step 108. The measured gradation between rock properties identified in the wellbore image loaded in step 102 and/or the core property selected in step 104 may be used as a constraint to the smoothing of the lithotype proportion map created in step 116. Upon completion of step 120, method 100 proceeds to step 122. In FIG. 5, an example of multiple depth referenced whole core images displayed along the vertical axis of the core in the constrained lithotype proportion map generated in step 120 is illustrated. The computed rock properties are displayed for the indexed region and where the amalgamated rock property listings represent an average for each slice (area) or indexed volume, as contemplated in connection with step 120.

In step 122, a facies simulation is generated using the lithotype proportion map created in step 116 or the smoothed lithotype proportion map generated in step 120, the facies log curve data loaded in step 102, the enhanced three-dimensional stratigraphic geocellular grid built in step 114 and applications well known in the art. A high resolution definition of the vertical and lateral facies relationships within each stratigraphic reservoir interval is created using the lithotype proportion map created in step 116, a variogram model, and a proportion map according to various methods known in the art. The facies simulation provides a template (spatial constraint) for the distribution of petrophysical properties by facies and interval.

In step 124, the method 100 determines whether to create a small or multi-scale facies simulation based on the intent to capture small length scale trends that could not be constrained spatially considering a focused spatial constraint solely characterized by lower frequency spatial depositional facies variation. If no small or multi-scale facies simulation is to be created, then the method 100 proceeds to step 126. If a small or multi-scale facies simulation is to be created, then the method 100 proceeds to step 128.

In step 126, a small or multi-scale facies simulation is created by refining the enhanced three-dimensional stratigraphic geocellular grid built in step 114, using the lithotype proportion map created in step 116 or the constrained lithotype proportion map created in step 120, and the facies log curve data loaded in step 102. Method 100 thus allows the creation of a small scale facies simulation that is to scale with respect to available wellbore or core image or a multi-scale facies simulation that ties the wellbore/core image or segmentation scale to the log scale, i.e. a generated earth model with varying scale dependent on the focus area defined by user specification resulting from log and wellbore/core image or segmentation data. Multi-scale assumes that grid refinement in the vertical direction is coincident with respect to larger grid cells, i.e. there is no overlap and all grid cell edges (borders) are congruent. This small scale facies simulation may be treated as a refined model, which may be incorporated, depending on the spatial and geometric definition of the small scale grid, into a region belonging to a larger grid through grid merging. The small or multi-scale facies simulation is populated with petrophysical properties as known in the art. With tensor related properties being assigned to the subsurface images or segmented images (permeability, connected porosity, stress with more than one or all three axial components—in other words UK orientation) those properties may be distributed according to their respective spatial dependence. This enhances the classical modeling capabilities to fully capture subsurface heterogeneity and anisotropy according to the tensor orientation of the rock property distributed in space. This tensor based capability may be defined in stacked two dimensional images (segmented into three dimensional reconstructions), but does not exist in traditional modeling based on logs as well logs are construed as an a direction independent average property specified over a particular depth interval. In FIG. 8B, an example of a top view of a singular pointset data property co-incident with the stacked circular display pointset of FIG. 8A illustrating directional (axial) permeability [K(x,y)] data and porosity [Phi(x,y)] data prior to generation of the static earth model in step 128 is illustrated.

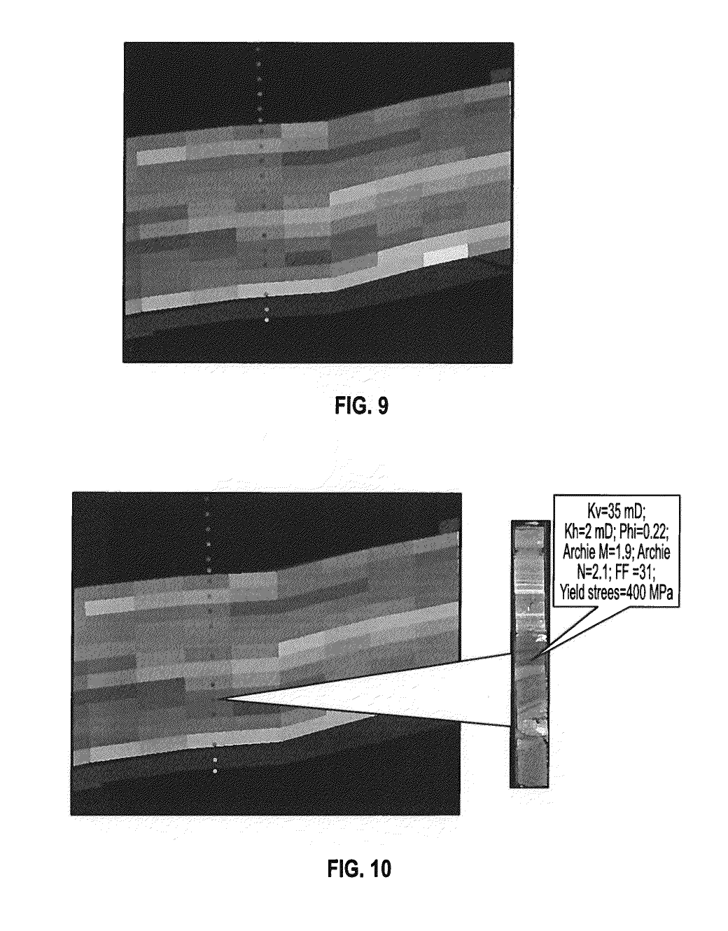

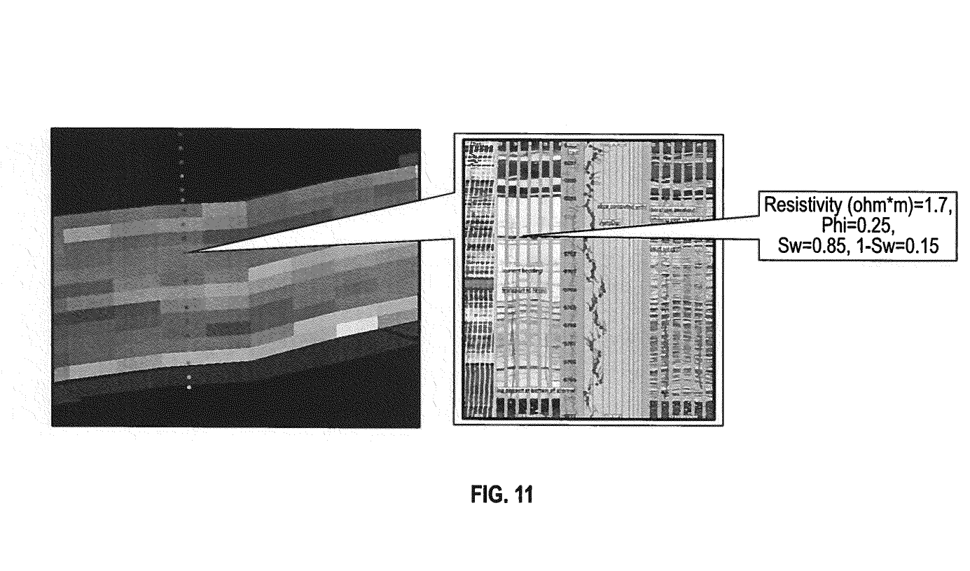

In step 128, a static earth model is generated using the enhanced three-dimensional stratigraphic geocellular grid built in step 114, the facies simulation generated in step 122, the modified well log property curve data created in step 110, the porosity data loaded in step 102, the permeability data loaded in step 102, and, if present, the small or multi-scale facies simulation created in step 126. The static earth model may be created in more than one direction in x and/or y orientation using tensor data from the core property data assigned to the wellbore image data loaded in step 102. Multiple realizations of three dimensional static earth models may thus be calculated to perform static volumetric computations with the requisite purpose of ranking multiple realizations, perform uncertainty analysis and execute flow simulation jobs to assess the effect of petrophysical property variations on flow in the reservoir according to various methods known in the art. The static earth model may then act as input into a numerical reservoir simulator in order to simulate production from the modeled reservoir. The method 100 results in the images of FIGS. 2-7 being geo-referenced so that they are coincident with the present well trajectory or another user defined datum—i.e. Kelly bushing, geologic feature/event, etc. In FIG. 9, an example of a geocellular mapped property/grid visualization where the mapped permeability is superimposed on a background permeability grid (field) in the static earth model generated in step 128 is illustrated. In FIGS. 10 and 11, examples of the appearance of image data used to generate a property mapped to the geocellular grid created in step 126, and subsequently the physical rock property volumes, that would be linked to the images, are illustrated. In FIG. 10, an example, not related to data from FIGS. 2-11 including the background geocellular permeability volume, of a geocellular mapped permeability property superimposed on a background permeability grid (field) with a geo-referenced computed tomography scan of whole core including its associated rock properties is illustrated. In FIG. 11, another example, not related to data from FIGS. 2-11 including the background geocellular permeability volume, of a geocellular mapped permeability property superimposed on a background permeability (field) with a geo-referenced log including its associated rock properties in a static earth model generated in step 128.

The method 100 provides the capability to work with quantitative data enhanced images, with image segmentation and property core and cuttings data (which would be managed such as images), segmented core volumes, petrographic, petrophysical, digital rock physics, routine core analysis, special core analysis, spreadsheet data, as well as any other meta data associated with a particular well log.

The method 100 allows visualization, analysis, and construction of three-dimensional geo-cellular earth models from aggregated two-dimensional images of core property data (or averaged cuttings per interval). The associated images, regardless of type, are appropriately geo-referenced and used in a manner analogous to or in conjunction with digitized well logs and well logs mapped to the geocelluar grid. Thus method 100 adds a quantitative dimension over the prior art and provides for inclusion of products and results obtained from digital and physical laboratories. Unlike the prior art, method 100 provides an earth modeling package that allows the input and spatial propagation of axial dependent properties, effectively computing tensor permeabilities (and connected porosity if desired) along the X, Y and Z axis orientations.

The method 100 incorporates axial dependent rock property data, referenced to images, in the earth model construction process. Unlike the prior art, the method 100 builds an earth model that is enhanced by tensor characterized properties, i.e. direction oriented permeability, connected porosity, stress with all there axial components as a result of step. The method 100 better honors subsurface heterogeneity and anisotropy and provides the capability to build small or multi-scale static earth models. Moreover, the method 100 permits geo-referencing images to other existing images that are of differing or similar scale—i.e. referencing core/wellbore images to a geocellular model and the use of in-situ wellbore images/quantitative data to build a static earth model upon completion of the method 100.

By incorporating core, cuttings and in-situ wellbore data into the building of a static earth model, the method provides the ability to honor data from sources other than well logs, be able to enhance the qualitative characteristics of regular images with quantitative properties for direct modeling and provide it with the ability to spatially propagate directionally sensitive properties as they are recognized in the subsurface—once mapped properties to the geocellular grid are modified to facilitate tensor based characteristics.

The method 100 involves the importing of rock images and/or segmented volumes into management software, and then using these images to populate an earth model analogous to the traditional digitized well log curve that represents a singular spatial data point that is direction independent. All available rock property information is viewable by user selection for any interval where it exists and the user has control over the specific rock property displayed. As a result, the principle of displaying images with geo-referenced properties may be applied along any axial direction—permitting the analysis of vertical or horizontal rock property transitions in whole core.

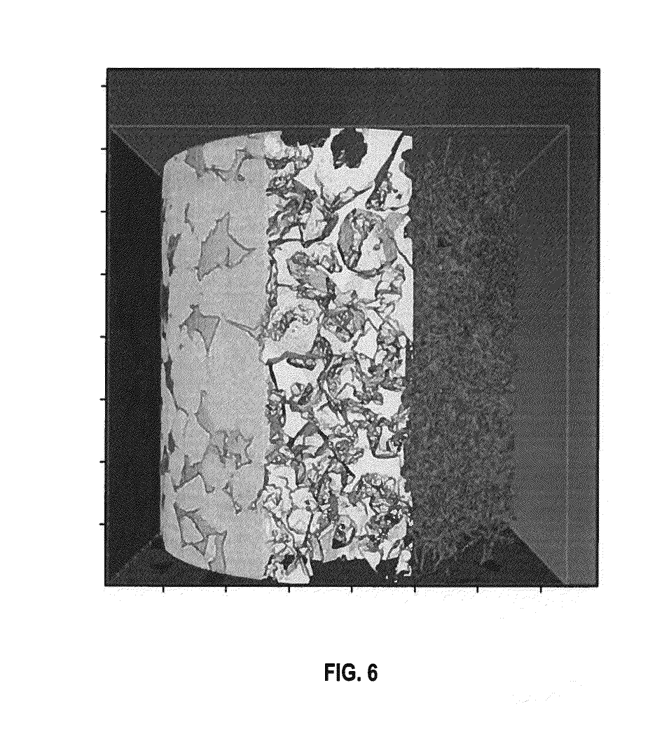

It is recognized that the images are qualitative in nature and as a result some degree of quantification of an illustrated rock property is required. This is to be achieved through manual, spreadsheet data input or input of a segmented volume—property, referenced to the image of a core, or digitized area from a single image or volume from multiple computed tomography scan images or EMI, creating “rock bodies” as illustrated in FIG. 6, In FIG. 6, an example of a core segmentation, derivative of the assigned wellbore image data created in step 108, derived from computed tomography images, wherein segmentation allows quantitative properties to be assigned to amalgamated areas and regions in computed tomography data related to step 102, is illustrated. Once segmented or indexed petrophysical, mechanical, routine and/or special core analysis derived properties may be assigned to the rock bodies completing their quantitative definition. Should actual computed tomography scan images of a core be present, processing algorithms may be implemented to apply similar upscaling (averaging) techniques to them, as would be done to properties mapped to the geocellular grid, to reference the scan images to the under-sampled property grid. The assigned rock properties may be retrieved by a user for visualization, data analysis and mapping properties to the geocellular grid for the construction of an earth model.

Due to possible lateral heterogeneity that may be present in the rock—and subsequently captured in routine and special core analysis, the creation of a “tensor based mapped property to the geocellular grid” is necessary. This allows X and Y axial specific properties to be saved, blocked to the grid and accordingly propagated with the appropriate algorithms—as opposed to a singular direction independent property being assigned to the grid.

The standard approach of importing a log curve and mapping it to the geocelluar grid for the purposes of grid blocking is extended to include images derived from wellbore image analysis as well as axial core and cuttings data derived from digital or physical laboratory such as computed tomography, photographic or thin section images. Due to the axial characteristics of the quantitative core and cuttings data, the data type would necessitate the ability to have quantifiable axial components defined. If plotted, the original well log curves as input into the computer system would appear as illustrated in FIG. 2. Traditional discrete LAS log data points are mapped and blocked to the geocellular grid through an upscaling (averaging) process guided by a sampling parameter which correlates to the vertical dimension of the grid as illustrated in FIG. 3, which illustrates a continuous well log with display of core curves of permeability.

### System Description

The present disclosure may be implemented through a computer executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. DecisionSpace®, which is a commercial software application marketed by Landmark Graphics Corporation, may be used as interface applications to implement the present disclosure. The software may also cooperate with other code segments to initiate a variety of tasks in response to data received in conjunction with the source of the received data. This may include use of various modules of DecisionSpace®, for example, Earth Modeling, Petrophysics, and Geographical Information System (GIS), providing an integrated technology approach to asset evaluation and development. The method 100 utilizes a database to facilitate linking quantitative properties to images or segmentation data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 12, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer executable instructions, executed by the computing unit for implementing the present disclosure described herein and illustrated in FIG. 1. The memory therefore, includes an in-situ wellbore, core and cuttings information system module, which enables the methods described in reference to FIG. 1. The foregoing modules and applications may integrate functionality from the remaining application programs illustrated in FIG. 12. In particular, DecisionSpace® may be used as an interface application to perform steps 102, 112, and to the extent a step incorporates well log property curves data or facies log curve data, steps 104, 110, 122, and 128 in FIG. 1. The in-situ wellbore, core and cuttings information system module performs the remainder of the steps in FIG. 1. Although DecisionSpace® may be used as an interface application, other interface applications may be used, instead, or the in-situ wellbore, core and cuttings information system module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

I claim:

1. A method for generating a static earth model, comprising:
building an enhanced three-dimensional stratigraphic geocellular grid using a three-dimensional stratigraphic geocelluar grid, wellbore image data and a computer system;
creating a lithotype proportion map using core property data, an assigned wellbore image, and the enhanced three-dimensional stratigraphic geocellular grid or generating a constrained lithotype proportion map by constraining a smoothing of a lithotype proportion map using trends found in properties of the assigned wellbore image;
generating a facies simulation using the lithotype proportion map or the constrained lithotype proportion map, and the enhanced three-dimensional stratigraphic geocellular grid; and
generating the static earth model using the enhanced three-dimensional stratigraphic geocellular grid, the facies simulation, a modified well log property curve, porosity data, and permeability data.

2. The method of claim 1, further comprising creating the assigned wellbore image by assigning the core property data to the wellbore image data.

3. The method of claim 1, further comprising creating the modified well log property curve using well log property curves data and the core property data.

4. The method of claim 1, further comprising building the three-dimensional stratigraphic geocellular grid using geologic framework data.

5. The method of claim 1 wherein the facies simulation is generated using the constrained lithotype proportion map.

6. The method of claim 1, wherein the static earth model is generated using a small or multi-scale facies simulation.

7. The method of claim 6, further comprising creating the small or multi-scale facies simulation by refining the enhanced three-dimensional stratigraphic geocellular grid using the lithotype proportion map or the constrained lithotype proportion map, and a facies log curve.

8. A non-transitory program carrier device tangibly carrying computer executable instructions for generating a static earth model, the instructions being executable to implement:
building an enhanced three-dimensional stratigraphic geocellular grid using a three-dimensional stratigraphic geocelluar grid and wellbore image data;
creating a lithotype proportion map using core property data, an assigned wellbore image, and the enhanced three-dimensional stratigraphic geocellular grid or generating a constrained lithotype proportion map by constraining smoothing of a lithotype proportion map using trends found in properties of the assigned wellbore image;
generating a facies simulation using the lithotype proportion map or the constrained lithotype proportion map, and the enhanced three-dimensional stratigraphic geocellular grid; and
generating the static earth model using the enhanced three-dimensional stratigraphic geocellular grid, the facies simulation, a modified well log property curve, porosity data, and permeability data.

9. The program carrier device of claim 8, further comprising creating the assigned wellbore image by assigning the core property data to the wellbore image data.

10. The program carrier device of claim 8, further comprising creating the modified well log property curve using well log property curves data and the core property data.

11. The program carrier device of claim 8, further comprising building the three-dimensional stratigraphic geocellular grid using geologic framework data.

12. The program carrier device of claim 8 wherein the facies simulation is generated using the constrained lithotype proportion map.

13. The program carrier device of claim 8, wherein the static earth model is generated using a small or multi-scale facies simulation.

14. The program carrier device of claim 13, further comprising creating the small or multi-scale facies simulation by refining the enhanced three-dimensional stratigraphic geocellular grid using the lithotype proportion map or the constrained lithotype proportion map, and a facies log curve.

15. A non-transitory program carrier device tangibly carrying computer executable instructions for generating a static earth model, the instructions being executable to implement:
building an enhanced three-dimensional stratigraphic geocellular grid using a three-dimensional stratigraphic geocelluar grid and wellbore image data;
creating an assigned wellbore image by assigning core property data to the wellbore image data;
creating a lithotype proportion map or generating a constrained lithotype proportion map by constraining a smoothing of a lithotype proportion map using trends found in properties of the assigned wellbore image;
generating a facies simulation using the lithotype proportion map or the constrained lithotype proportion map, and the enhanced three-dimensional stratigraphic geocellular grid; and
generating a static earth model using the enhanced three-dimensional stratigraphic geocellular grid, the facies simulation, a modified well log property curve, porosity data, and permeability data.

16. The program carrier device of claim 15, further comprising creating the modified well log property curve using well log property curves data and core property data.

17. The program carrier device of claim 15, further comprising building the three-dimensional stratigraphic geocellular grid using geologic framework data.

18. The program carrier device of claim 15 wherein the facies simulation is generated using the constrained lithotype proportion map.

19. The program carrier device of claim 15, wherein the static earth model is generated using a small or multi-scale facies simulation.

20. The program carrier device of claim 15, further comprising creating the small or multi-scale facies simulation by refining the enhanced three-dimensional stratigraphic geocellular grid using the lithotype proportion map or the constrained lithotype proportion map, and a facies log curve.
